(19) United States
(12) Patent Application Publication
(10) Pub. No.: US 2005/0007461 A1
(43) Pub. Date: Jan. 13, 2005

(54) Correction system and method of analog front end

(75) Inventor: Kuo-Yu Chou, HsinChu (TW)

Correspondence Address: TROXELL LAW OFFICE PLLC, SUITE 1404, 5205 LEESBURG PIKE, FALLS CHURCH, VA, 22041, US

(73) Assignee: Novatek Microelectronic Co.

(21) Appl. No.: 10/617,388

(22) Filed: Jul. 11, 2003

(51) Int. Cl. H04N 5/228

(52) U.S. Cl. 348/222.1

(57) ABSTRACT

The present invention is a correction system applying in an analog front end(AFE). The correction system comprises a correction module, a first digital to analog converter(DAC1) and a second digital to analog converter(DAC2). The correction is used to generate a gain error correction and black pixel signal error correction when the black pixel signal is inputted into the AFE. The correction module corrects the digital output signals generated by the AFE according to the gain error correction. The correction module input the black pixel signal error correction to the DAC1 to generate a first analog correction signal to correct the signal inputted into the AFE. The present invention effectively corrects the signal error generated by the AFE to make the AFE output the corrected digital output signal.

### FIELD OF THE INVENTION

The present invention relates to a correction system and method of an analog front end, and more particularly, to a correction system and method of an analog front end applied in an image capture device.

### BACKGROUND OF THE INVENTION

Analog Front End (AFE) is an important device in an image-capturing device, for example, a digital camera, a digital video camera, etc. It is used to receive the pixel signals from the image sensor and convert the pixel signals to the digital signals for following process.

The analog pixel signals outputted by the image sensor should be processed with the signal modulation and the analog-to-digital conversion to be the digital output signals for following process. Please refer to FIG. 1, FIG. 1 is a schematic diagram of the conventional image capture device 10. The image capture device 10 captures the optical image by an optical system 12 and processes the signals by the following devices as an image sensor 14, an analog front end 16 and a digital processor18.

The analog front end 16 is used to modulate the signal outputted by the image sensor 14, amplify the analog pixel signal to a predetermined level, convert the amplified analog signal to a digital output signal, and output the digital output signal to the digital processor 18. The image sensor 14 comprises a color filter array to identify different colors. The color filter array comprises a plurality of pixel units with different colors. The pixel unit is used to identify colors by beam splitting. Please refer to FIG. 2, FIG. 2 is a schematic diagram of the pixel units of the image sensor 14 in FIG. 1. The image sensor 14 comprises a plurality of black pixel units (N) and a plurality of three primary colors pixel units (RGB). Different pixel units generate different responsive signal with the same input. For example, if the image sensor 14 accepts white light, the signal generated by the green pixel unit G is stronger than the signals generated by the red pixel unit R or the blue pixel unit B.

As shown in FIG. 2, the image sensor 14 includes a sensitive region and an insensitive region. The sensitive region is the region of the R, G and B pixel unit. The insensitive region is the region of the N pixel unit. The output order of the pixel signals depends on the arrangement of pixel units in the color filter and the scanning method of the image sensor 14. The conventional output order is usually a single channel sequence, which outputs the plurality of N pixel signal first, then outputs the RGB pixel signals and outputs further N pixel signals in the last in one channel. The signal level should be zero when the signals outputted by the N pixel unit. Owing to the error of the devices, the image sensor 14 often outputs signals higher than zero. This problem makes error of the following signals outputted by the sensitive region.

The digital processor 18 comprises an image process and timing control circuit (not shown in FIG. 2). The digital processor 18 is used for digital signal processing such as image analysis, parameter modulation and image enhancement, etc. The image capture device 10 has different applications such as camera, scanner or photostat, etc. The circuit after the digital processor 18 is various with various applications.

FIG. 3 is a schematic diagram of the AFE 16 in FIG. 1. The known AFE 16 of the image-capturing device 10 comprises a correlated double sampling module (CDS) 22, a variable gain amplifier (VGA) 24, and an analog-to-digital converter (ADC) 26.

The CDS 22 is used for generating an analog sampling signal by sampling the pixel signals outputted by the image sensor 14. The sampling method is a correlated double sampling method, each pixel signal being sampled twice; one is sampled at the present level of the signal, and the other is sampled at the video level. The analog sampling signal is the differential of the two sampled signals. The CDS 22 has the features of resisting correlated noise and low frequency floating caused by the image sensor 14. The signal-noise ratio (SNR) of the AFE 16 gets improvement due to the features of the CDS 22.

The VGA 24 is placed after the CDS 22. The analog sampling signal should be amplified to a predetermined level, which fits the requirement of the ADC 26, and should optimally use the dynamic range of the ADC 26. The gain factor of the VGA 24 for amplifying the analog sampling signal changes with different images under the control of the digital processor 18.

In order to make all the signals outputted by the image sensor to fully use the dynamic range of the ADC 26, the VGA 24 has to satisfy the requirement of setting different gain factors with different images. If a fixed gain amplifier is used, the strong signal could fully use the dynamic range of the analog-to-digital converter to have a better SNR. On the contrary, the weak signal has a worse SNR due to the incomplete use of the dynamic range of the ADC 26.

The ADC 26 converts the analog signal, which is amplified and outputted by the VGA 24, to a digital signal for further processing by digital processor 18.

In ideal, the pixel signals outputted from the insensitive region of the image sensor 14 should be equal to the present level and the video level. In other words, the level of pixel signals outputted from the black pixel units should be zero. In fact, the black pixel signal is even higher than 100 mV due to the inevitable noise such as device error. It is a fundamental error of the device and appears in R, G and B pixel signals as well as black pixel signals. In order to achieve the maximum of using the dynamic range of the analog-to-digital converter, the device error has to be corrected. Besides, many errors including the device error exist both in the VGA 24 and the ADC 26. Those errors cause an offset of the converting curve of the analog-to-digital converter, and make the pixel signal be converted to a wrong digital output signal.

So, it is necessary to add a correction circuit in the AFE 16 to correct the level offset of the black pixel signal outputted by the image sensor and the converting curve offset caused by the VGA 24 and the ADC 26.

### SUMMARY OF THE INVENTION

An objective of this invention is to provide a correction circuit applied in an analog front end to correct the level offset of the black pixel signals outputted by the image sensor and the converting curve offset caused by the variable gain amplifier and the analog-to-digital converter.

The present invention is a correction system applied in an analog front end. The analog front end is used to receive a plurality of pixel signals outputted by an image sensor, and then amplify and convert the plurality of pixel signals to a plurality of digital output signals.

The correction system is used to correct the digital output signals, and comprises a correction module, a first digital-to-analog converter and a second digital-to-analog converter. The operation of the correction system of the present invention has two major steps.

In first step, when the image sensor inputs the first black pixel signal, the correction module generates a first digital correction signal according to a difference between the digital output signal and a predetermined value. The first digital-to-analog converter receives and converts the first digital correction signal to a first analog correction signal. The first digital-to-analog converter then inputs the first analog correction signal to the analog front end to correct the pixel signals to make the level of following pixel signals below a predetermined value. The first digital-to-analog converter continually corrects the following pixel signals according to the first analog correction signal.

In second step, when the pixel signal inputted into the analog front end also represents the black pixel signal, the correction module generates not only the first digital correction signal but also at least a second digital correction signal. The second digital-to-analog converter is used to receive and convert at least a second digital correction signal to at least a second analog correction signal, and then input at least a second analog correction signal into the analog front end. The input pixel signal is already below the predetermined value because of the correction process in the first step, so the signals, which the analog front end is processing, are at least a second analog correction signal. Then, the analog front end amplifies and converts the second analog correction signal to at least a first digital signal. The correction module generates a real converting curve according to at least a first digital signal and gets a gain error by comparing the real converting curve with an ideal converting curve which represents the correct converting relationship between the digital output signals and the analog output signals. The correction module corrects the following digital output signals generated from the analog front end according to the gain error.

The present invention adjusts the level error of the black pixel signal first, and gets a digital signal by inputting and converting an indicated analog signal. The present invention further derives the real converting curve by at least two points (zero and at least a digital signal), and finally gets the gain error by comparing the real converting curve with the ideal converting curve. The correction system in the present invention can adjust the output signal from the analog front end according to the gain error.

We can further get the essence and advantage of this invention by the following drawings and detailed description.

### BRIEF DESCRIPTION OF THE DRAWINGS

FIG. 1 is a schematic diagram of the conventional image capture device.

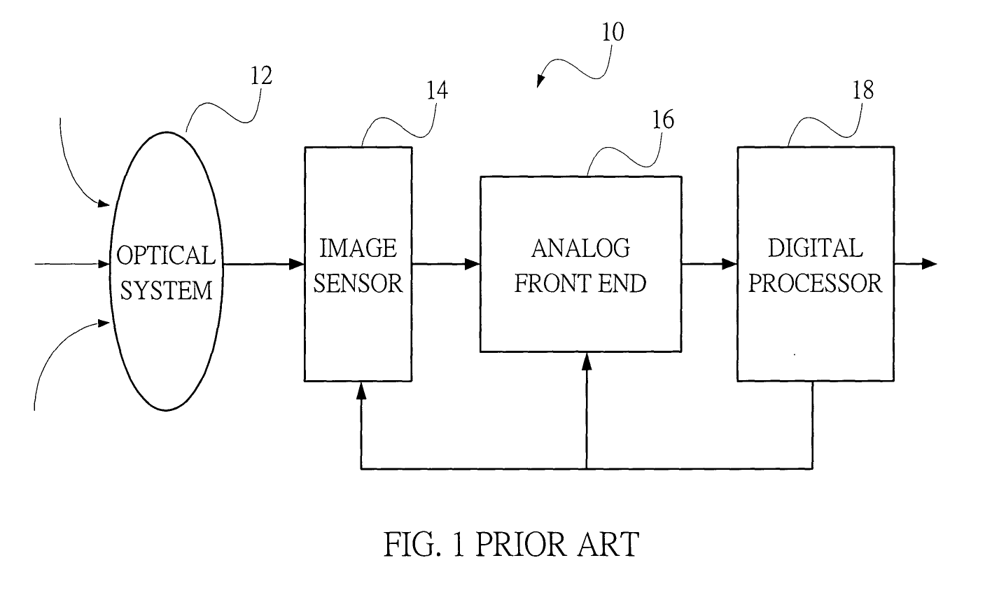

FIG. 2 is a schematic diagram of the pixel units of the image sensor in FIG. 1.

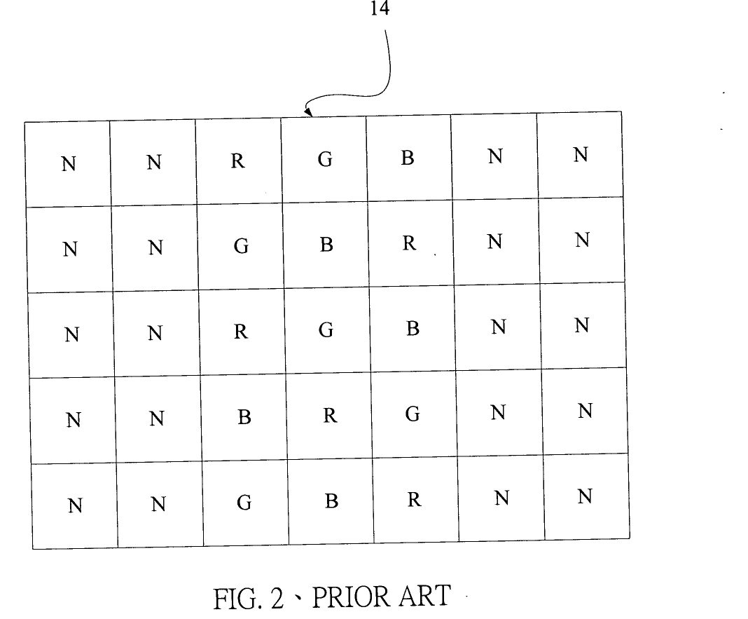

FIG. 3 is a schematic diagram of the AFE in FIG. 1.

FIG. 4 is a schematic diagram of an image sensor and an AFE with a correction system according to the present invention.

FIG. 5 is a schematic diagram of the correction system and the analog front end in FIG. 4.

FIG. 6 is a schematic diagram of the ideal converting curve and the converting curve with error.

FIG. 7 is a schematic diagram of the ideal converting curve and the real converting curve of another embodiment according to the present invention.

FIG. 8 is the flow chart of the correction method according to the present invention.

### DETAILED DESCRIPTION OF THE PREFERRED EMBODIMENT

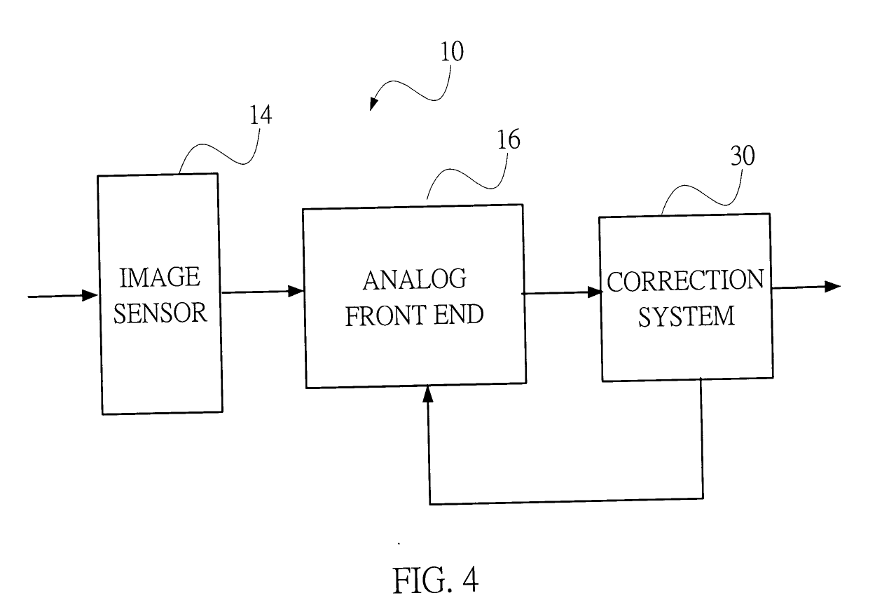

Please refer to FIG. 4. FIG. 4 is a schematic diagram of an image sensor 14 and an AFE 16 with a correction system 30 according to the present invention. The present invention relates to a correction system 30 applied in an analog front end 16. The analog front end 16 is used to receive a plurality of pixel signals outputted by an image sensor 14 in a proper sequence and convert the plurality of pixel signals to a corresponding plurality of digital output signals after amplifying the plurality of pixel signals with a gain factor. In the preferred embodiment of this invention, the image sensor 14 is a charge couple device (CCD). In another embodiment, the analog front end 16 is used to amplify and convert a plurality of analog output signals, which is received from a signal source in proper sequence, to a corresponding plurality of digital output signals. The plurality of analog output signals include a plurality of basis signals and a plurality of content signals. Each basis signals has a signal level and each content signal represents the contents that the signal source wants to transmit. The correction system 30 according to the present invention is used to correct the plurality of digital output signals to prevent from the drawbacks as mentioned in the prior art.

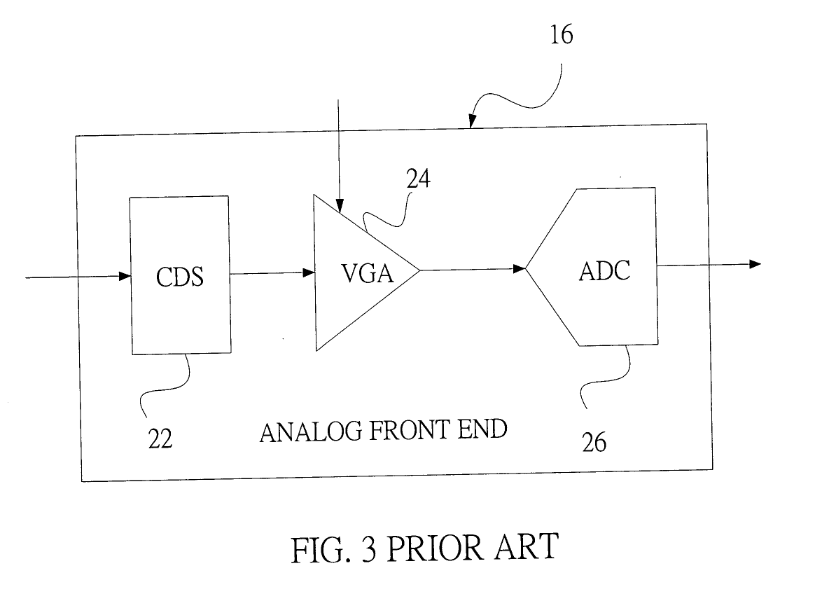

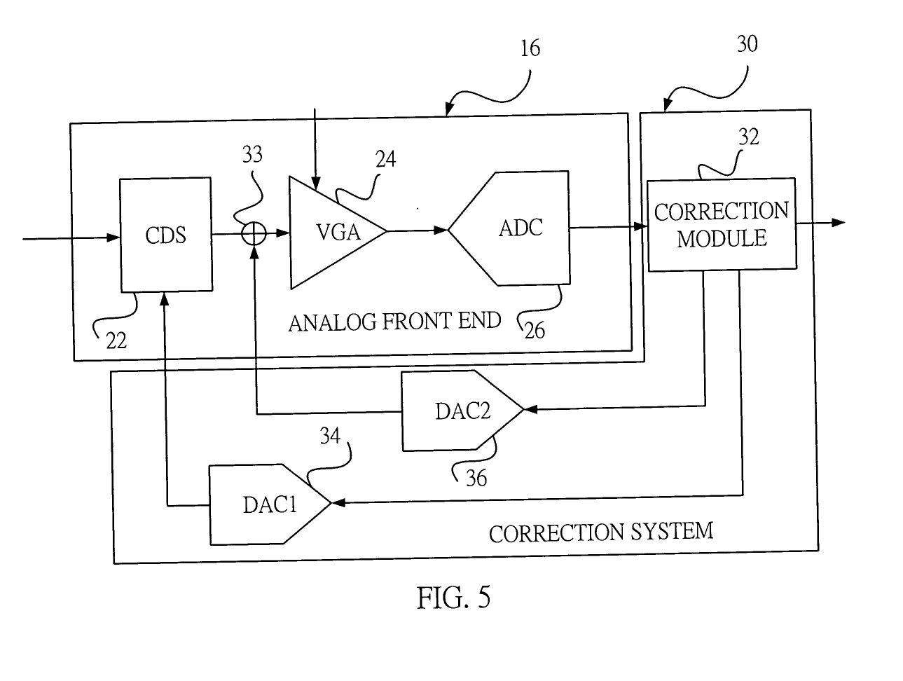

The correction system 30 is enabled when the image sensor 14 outputs black pixel signals. Please refer to FIG. 5. FIG. 5 is a schematic diagram of the correction system 30 and the analog front end 16 in FIG. 4. All elements of the analog front end 16 have been described in the background of the invention with FIG. 3 and no more description here. The correction system 30 comprises a correction module 32, a first digital-to-analog converter 34 (shown in FIG. 5 as DAC1) and a second digital-to-analog converter 36 (shown in FIG. 5 as DAC2). The correction system 30 is enabled in the insensitive region of the image sensor so never influences the normal operation of the image sensor. The whole optical system is not necessary to temporarily stop while the correction is actuated.

When the pixel signal represents a black pixel signal which is outputted from the black pixel unit in the image sensor, in ideal, the signal level of the analog sampling signal which is obtained by double sampling the pixel signal by the CDS 22 should be zero. Due to the inevitable error of device, as the above description, the analog sampling signal even has a signal level up to 100 mV. At the same time, the analog front end still amplifies and converts the analog sampling signal with error to a digital output signal. So the correction system 30 starts to reduce the signal error to a predetermined value in order to fully use the dynamic input range of the analog-to-digital converter 26.

As shown in FIG. 5, the correction module 32 generates a first digital correction signal according to the difference between the digital output signal and the digital signal corresponding to the predetermined value. And then the correction module 32 inputs the first digital correction signal, which is used to compensate the error of the devices, to the first digital-to-analog converter 34. The first digital-to-analog converter 34 receives and converts the first digital correction signal to a first analog correction signal and then inputs the first analog correction signal to the CDS 22 in the analog front end 16 to correct the following pixel signals. The correction module 32 continues checking whether the digital output signal is below the predetermined value during the image sensor 14 outputs the black pixel signals of the black pixel units. When the analog sampling signal is below the predetermined value, the first digital correction signal at that time can be used to compensate the error of the devices. The correction module 32 using the first digital correction signal inputted into the first digital-to-analog converter 34 continuously corrects the following analog sampling signals, which is inputted to the CDS 22. In the preferred embodiment of this invention, the predetermined value is zero.

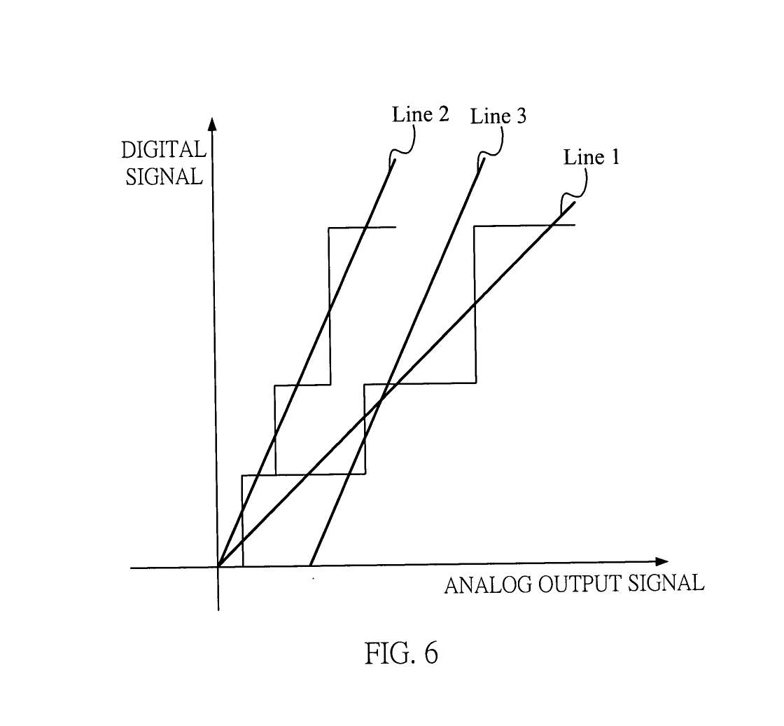

Generally, the gain error and the offset exist in the analog-to-digital converter 26. The offset represents the level error of the analog sampling signal of the black pixel signal. FIG. 6 is a schematic diagram of the ideal converting curve and the converting curve with error. As shown in FIG. 6, Line 1 means an ideal converting curve. Line 2 means a converting curve with gain error. Line 3 means a converting curve with gain error and offset. In fact, the converting curve of the conventional analog front end is close to Line 3 but the offset is not always positive. In order to correct Line 3, the offset and the slope of Line 3 must obtain in advance. In other words, except the previous level error, two points on Line 3 must be obtained in order to estimate the slope.

The main purpose of the second digital-to-analog converter 36 is to correct the converting curve of the analog-to-digital converter 26. The second digital-to-analog converter 36 doesn't actuate until the black pixel signals have been corrected. That means the signal outputted to the VGA 24 is zero. The second digital-to-analog converter 36 starts to work when the digital output signal is below the predetermined value (that means the offset is zero). And the correction module 32 inputs a second digital correction signal to the second digital-to-analog converter 36. The second digital-to-analog converter 36 receives and converts the second digital correction signal to a second analog correction, and then inputs the second analog correction signal to an adder 33. The adder 33 inputs the mixed analog sampling signal to the VGA 24 in the analog front end 16.

The present analog sampling signal has been corrected, and can be supposed as zero. The VGA 24 amplifies the second analog correction signal indicated by the correction system 30. After converted by the ADC 26, a first digital signal will be generated. As shown in FIG. 5, the adder 33 is placed in front of the VGA 24. In another embodiment of the present invention, the adder 33 is placed in back of the VGA 24. In this embodiment, the second analog correction signal is mixed with the amplified black pixel signal. Because the black pixel signal has been corrected to zero, the ADC 26 directly converts the second analog correction signal to a first digital signal.

The correction module 32 derives the real converting curve of the analog front end 16 according to the first digital signal and the origin. The correction module 32 derives a gain error by comparing the real converting curve with an ideal converting curve. The ideal converting curve represents the correct converting relationship between the plurality of analog output signals and the plurality of digital output signals. The correction module corrects the following digital output signals generated by the analog front according to the gain error.

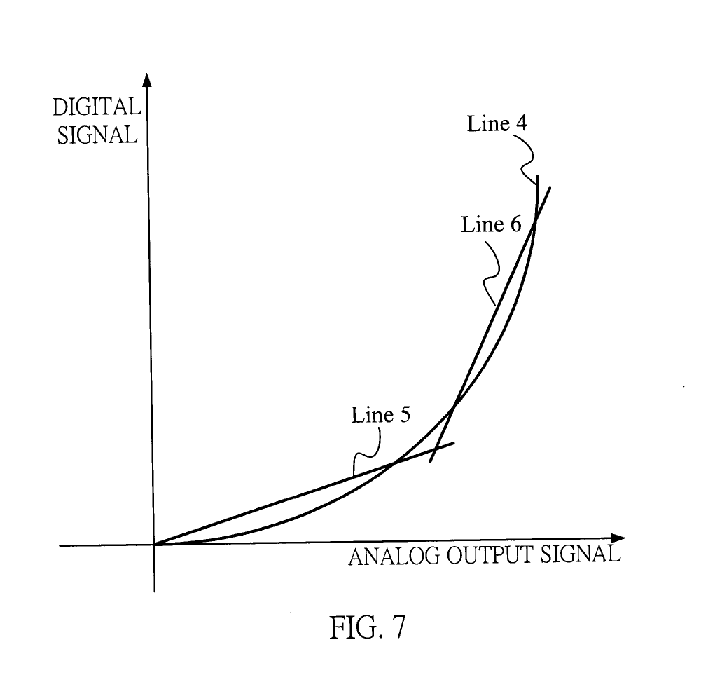

FIG. 7 is a schematic diagram of the ideal converting curve and the real converting curve of another embodiment according to the present invention. If the real converting curve Line 4 is a curved line, it is impossible to correct the error completely by a straight line. The method of this present invention is that the curve can be divided into two segments or multi-segments to correct. After the black pixel signal has been corrected, the correction module 32 generates a plurality of second digital correction signals and inputs the plurality of second digital correction signals into the second digital-to-analog converter 36. The second digital-to-analog converter 36 converts the plurality of second digital correction signals to a plurality of second analog correction signals and inputs the plurality of second analog correction signals into the adder 33 to derive a plurality of first digital signals from amplifying and converting the plurality of second analog correction signals by the analog front end 16. The correction module 32 generates a plurality of segmental converting curves, Line 5 and Line 6, according to the origin and the plurality of first digital signals. Then construct the plurality of segmental converting curves to a real converting curve and get a plurality of gain errors of multi-segments by comparing the real converting curve with the ideal converting curve. Then correct the digital output signals of each segment by the gain errors of the same segment.

The point emphasized here is that the correction system 30 of the present invention starts to correct after receiving the first black pixel signal and continuously correct the following input pixel signals and digital output signals after getting the first analog correction signal and the gain error. Due to the different arrangements of the pixel units of different image sensors, in another embodiment of this invention, the sequence of the pixel units is a black pixel unit in front of a plurality of R, G and B pixel units. The correction system 30 of this invention starts to correct after receiving the first black pixel signal and waits for the next input black pixel signal after the R, B and G pixel signals for the following correction. The correction module won't correct the following pixel signals and digital output signals until get the first analog correction signal and gain error.

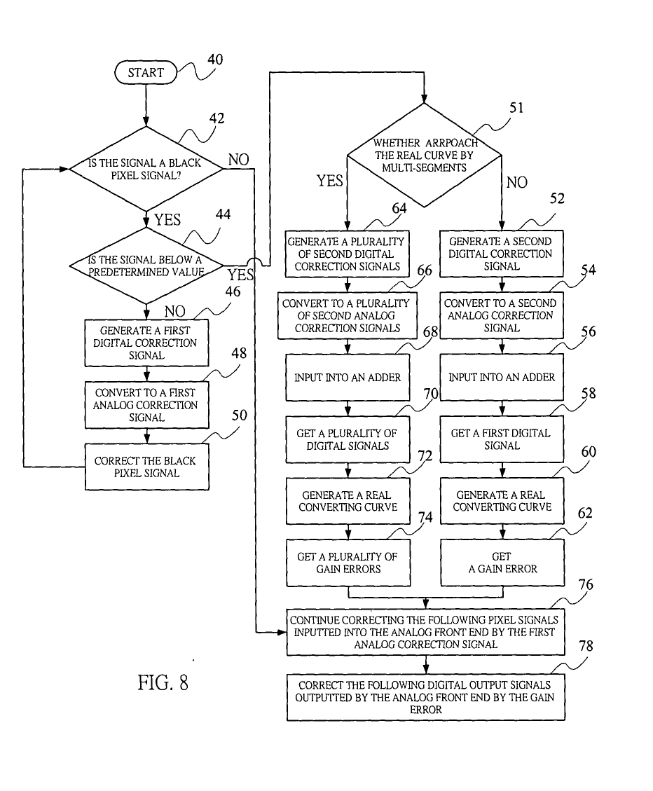

FIG. 8 is the flow chart of the correction method according to the present invention. According to the above mention, the method of this present invention comprises:

Step 40: Start.

Step 42: Determine whether the pixel signal is a black pixel signal. If yes, go to Step 44. If not, go to Step 76 Step 44: Determine whether the level of the analog sampling signal, which is got by double sampling the pixel signal, is below a predetermined value. If yes, go to Step 51. If not, go to Step 46.

Step 46: Generate a first digital correction signal according to the difference between the level and the predetermined value.

Step 48: Convert the first digital correction signal to a first analog correction signal.

Step 50: Input the first analog correction signal to the CDS 22 to correct the black pixel signal and return to Step 42.

Step 51: Determined whether the correction module 30 approaches the real curve by a plurality of segmental curves. If yes, go to Step 52, If not, go to Step 64.

Step 52: Generate a second digital correction signal.

Step 54: Convert the second digital correction signal to a second analog correction signal.

Step 56: Input the second analog correction signal into an adder 33.

Step 58: Get a first digital signal converted from the second analog correction signal by the analog front end 16.

Step 60: Generate a real converting curve according to the first digital signal and the origin.

Step 62: Get a gain error by comparing an ideal converting curve with the real converting curve, and go to Step 76.

Step 64: Generate a plurality of second digital correction signals.

Step 66: Convert the plurality of second digital correction signals to a plurality of second analog correction signals.

Step 68: Input the plurality of analog correction signals into the adder 33.

Step 70: Get a plurality of first digital signals converted from the second analog correction signal by the analog front end 16.

Step 72: Generate a plurality of segmental converting curves according to the origin and the plurality of first digital signals, and further construct the plurality of segmental converting curves to a real converting curve.

Step 74: Get a gain error by comparing an ideal converting curve with the plurality of segmental converting curves.

Step 76: Continue to correct the following pixel signals inputted into the analog front end according to the first analog correction signal.

Step 78: Correct the following digital output signals generated by the analog front end according to the gain error.

Summing up the above mentions, the gain error and the level error of black pixel signals exist in the analog front end 16. This invention starts with adjusting the level error of the black pixel signals; next inputting the indicated analog signal to get a digital signal converted; further getting the real converting curve of the analog front end by two points or multi-points and finally getting the gain error by comparing the real converting curve with the ideal converting curve. The correction system can modulate the output results according to the gain error so the present invention is useful to improve the drawback of the analog front end without the correction system.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A correction system of an analog front end, the analog front end being used to receive a pixel signal outputted by a image sensor and convert the pixel signal to a digital output signal after amplifying the pixel signal, the image sensor comprising a plurality of black pixel units and a plurality of RGB pixel units, and outputting a plurality of black pixel signals and a plurality of RGB pixel signals, the correction system being used to correct the digital output signal, and comprising:
a correction module for
receiving the digital output signal; and
generating a first digital correction signal and at least one second digital correction signal when the image sensor outputs black pixel signals;
a first digital-to-analog converter for
receiving the first digital correction signal and converting the first digital correction signal to a first analog correction signal; and
inputting the first analog correction signal to the analog front end to correct the pixel signal inputted into the analog front end; and
a second digital-to-analog converter for
receiving the at least one second digital correction signal and converting the at least one second digital correction signal to at least one second analog correction signal; and
inputting the at least one second analog correction signal to the analog front end to be amplified and converted, then getting at least one first digital signal;
wherein the correction module generates a real converting curve according to the at least one first digital signal and gets a gain error by comparing the real converting curve with a ideal converting curve which presents the correct converting relation between the analog output signal and the digital output signal; and
wherein the correction module corrects the following pixel signals inputted into the analog front end according to the first analog correction signal, and corrects the following digital output signals generated by the analog front end by the gain error.

2. The correction system of claim 1, wherein the analog front end comprises a correlated double sampling module (CDS), a variable gain amplifier (VGA), and an analog-to-digital converter, the CDS being used to generate an analog sampling signal by receiving the pixel signal and double sampling the pixel signal; the VGA with plurality of gain factor being used to amplify the analog sampling signal with different gain factor according to different image captured by the image sensor; the analog-to-digital converter being used to convert the amplified analog sampling signal to the digital output signal.

3. The correction system of claim 2, wherein the first analog correction signal is inputted into the CDS in order to correct the analog sampling signal.

4. The correction system of claim 2, wherein the at least one second analog correction signal is inputted into the VGA in order to get the at least one first digital signal after amplified by the VGA and converted by the analog-to-digital converter.

5. The correction system of claim 2, wherein the at least one second analog correction signal is inputted into the analog-to-digital converter in order to get the at least one first digital signal after converted by the analog-to-digital converter.

6. The correction system of claim 1, further comprising a predetermined value, wherein the level of the corrected pixel signal is below the predetermined value.

7. The correction system of claim 1, wherein the correction module generates a plurality of converting curve segments according to the at least one first digital signal, and the real converting curve is composed of the plurality of converting curve segments.

8. A correction method of an analog front end, the analog front end being used to receive a pixel signal outputted by a image sensor and convert the pixel signal to a digital output signal after amplifying the pixel signal, the image sensor comprising a plurality of black pixel units and a plurality of RGB pixel units, and outputting a plurality of black pixel signals and a plurality of RGB pixel signals, the correction method being used to correct the digital output signal, and comprising the following steps:
receiving the digital output signal;
generating a first digital correction signal and at least one second digital correction signal when the image sensor outputs black pixel signals;
converting the first digital correction signal to a first analog correction signal;
inputting the first analog correction signal to the analog front end to correct the pixel signal inputted into the analog front end;
converting the at least one second digital correction signal to at least one second analog correction signal;
inputting the at least one second analog correction signal to the analog front end to be amplified and converted, then getting at least one first digital signal;
generating a real converting curve according to the at least one first digital signal and getting a gain error by comparing the real converting curve with a ideal converting curve which presents the correct converting relation between the analog output signal and the digital output signal;
correcting the following pixel signals inputted into the analog front end according to the first analog correction signal; and
correcting the following digital output signals generated by the analog front end by the gain error.

9. The correction method of claim 8, wherein the analog front end comprises a correlated double sampling module (CDS), a variable gain amplifier (VGA), and an analog-to-digital converter, the CDS being used to generate an analog sampling signal by receiving the pixel signal and double sampling the pixel signal; the VGA with plurality of gain factors being used to amplify the analog sampling signal with different gain factor according to different image captured by the image sensor; the analog-to-digital converter being used to convert the amplified analog sampling signal to the digital output signal.

10. The correction method of claim 9, wherein the first analog correction signal is inputted into the CDS in order to correct the analog sampling signal.

11. The correction method of claim 9, wherein the at least one second analog correction signal is inputted into the VGA in order to get the at least one first digital signal after amplified by the VGA and converted by the analog-to-digital converter.

12. The correction method of claim 9, wherein the at least one second analog correction signal is inputted into the analog-to-digital converter in order to get the at least one first digital signal after converted by the analog-to-digital converter.

13. The correction method of claim 8, further comprising the following step:
setting a predetermined value to make the level of the corrected pixel signal below the predetermined value.

14. The correction method of claim 8, further comprising the following step:
generating a plurality of converting curve segments according to the at least one first digital signal, wherein the real converting curve is composed of the plurality of converting curve segments.

15. A correction system for correcting a plurality of digital output signals generated by an analog front end, the analog front end being used to receive a plurality of analog output signals outputted by a signal source and convert the plurality of analog output signals to the plurality of digital output signals after amplifying the plurality of analog output signals, the plurality of analog output signals comprising a plurality of basis signals and a plurality of content signals, the basis signal comprising a signal level, the correction system comprising:
a correction module for
receiving the plurality of digital output signals; and
generating a first digital correction signal and at least one second digital correction signal when the signal source outputs basis signals;
a first digital-to-analog-converter for
receiving the first digital correction signal and converting the first digital correction signal to a first analog correction signal; and
inputting the first analog correction signal into the analog front end to correct the plurality of analog output signals generated by the signal source; and
a second digital-to-analog converter for
receiving the at least one second digital correction signal and converting the at least one second digital correction signal to at least one analog correction signal; and
inputting the at least one second analog correction signal to the analog front end to be amplified and converted, then getting at least one digital signal;
wherein the correction module generates a real converting curve according to the at least one first digital signal and gets a gain error by comparing the real converting curve with a ideal converting curve which presents the correct converting relation between the analog output signal and the digital output signal; and
wherein the correction module corrects the following analog output signals inputted into the analog front end according to the first digital correction signal, and corrects the following digital output signals generated by the analog front end according to the gain error.

16. The correction system of claim 15, wherein the analog front end comprises a correlated double sampling module (CDS), a variable gain amplifier (VGA), and an analog-to-digital converter, the CDS being used to generate a analog sampling signal by receiving and double sampling the analog output signal; the VGA with plurality of gain factors being used to amplify the analog sampling signal with different gain factor; the analog-to-digital converter being used to convert the amplified analog sampling signal to the digital output signal.

17. The correction system of claim 16, wherein the first analog correction signal is inputted into the CDS in order to correct the analog sampling signal.

18. The correction system of claim 16, wherein the at least one second analog correction signal is inputted into the VGA in order to get the at least one first digital signal after amplified by the VGA and converted by the analog-to-digital converter.

19. The correction system of claim 16, wherein the at least one second analog correction signal is inputted into the analog-to-digital converter in order to get at least one first digital signal after converted by the analog-to-digital converter.

20. The correction system of claim 15, further comprising a predetermined value, wherein the level of the corrected basis signal is below the predetermined value.
